(19) United States
(12) Patent Application Publication
(10) Pub. No.: US 2008/0270629 A1
(43) Pub. Date: Oct. 30, 2008

(54) Data snychronization and device handling using sequence numbers

(75) Inventors: Lie Yang, Palo Alto, CA (US); John A. Traver, Los Altos, CA (US); Bjorn Ebbesen, Hamburg (DE); Szymon Smyka, Hamburg (DE)

Correspondence Address: MORRISON & FOERSTER LLP, 755 PAGE MILL RD, PALO ALTO, CA, 94304-1018, US

(73) Assignee: Yahoo! Inc., Sunnyvale, CA (US)

(21) Appl. No.: 11/796,258

(22) Filed: Apr. 27, 2007

(51) Int. Cl. G06F 15/16

(52) U.S. Cl. 709/248

(57) ABSTRACT

A synchronization device such as a synchronization server or gateway device for synchronizing a client device with a remote database is provided. In one example, the synchronization devices comprises logic operable to receive a client message and a sequence number associated therewith, compare the received sequence number with a stored sequence number, and cause a response based on the comparison of the received sequence number and the stored sequence number. For example, the comparison of the sequence numbers may indicate the previous response to the client device was successfully received or needs to be resent. Further, the comparison of the sequence numbers may indicate that the client device has lost state (e.g., is out of sync with the database) and needs to refresh or perform a slow synchronization process with the database.

### RELATED APPLICATIONS

This application is related to U.S. patent application Ser. No. 11/182,287, filed Jul. 14, 2005, entitled CONTENT ROUTER, to Torsten Schulz et al., and Ser. No. 11/273,891, filed Nov. 14, 2005, entitled DATA SYNCHRONIZATION AND DEVICE HANDLING, to L. Yang et al., both of which are hereby incorporated by reference in their entirety as if fully set forth herein.

### BACKGROUND

1. Field

The present invention relates generally to data synchronization between two or more devices, and in one aspect, to a synchronization method and system using a sequence number associated with message exchanges (e.g., requests and responses) for improving data integrity during synchronization processes.

2. Description of Related Art

A variety of mobile computing devices exist, such as personal digital assistants (PDAs), mobile phones, smart phones, camera phones, pocket personal computers, and the like which perform an ever growing variety of functions. The trend is for mobile computing devices to have increased functionality such that a single mobile device may, for example, provide Internet access, maintain a personal calendar, provide mobile telephony, take digital photographs, play music files, and the like.

Data on such mobile computing device can be synchronized with network applications, desktop computer applications, or other databases within a telecommunications system. For example, calendar entries, contact information, and email applications, in particular, may be synchronized between multiple devices via a communication system. The SyncML (Synchronization Markup Language), which is based on the XML (eXtensible Markup Language) is well known for the synchronization of data between two or more devices, e.g., a client device and a server device. The SyncML synchronization protocol using messages in the SyncML format (SyncML messages) generally allows for synchronization of data in any application between any networked terminals. For example, a calendar entry in a user device synchronized with a network calendar.

FIG. 1 illustrates an example of system where a client device, e.g., a cell phone or other mobile device, functions as a SyncML client terminal and a data source, e.g., a computer or network server computer, functions as the SyncML server. SyncML client terminal synchronization application layer functions are provided by a synchronization client agent, which implements the SyncML protocol by sending a SyncML package (e.g., Client Modifications), which includes, in one or more SyncML messages, modifications made after the last synchronization session to the data that is the object of synchronization in the mobile device. SyncML/data source server synchronization application layer functions are provided by a sync server agent, which controls synchronization. The server usually waits for an initiative for synchronization from the SyncML client. The server synchronizes the data by analyzing the changes made to the database and client terminal data, and synchronizes the data (i.e., makes necessary modifications, replacements, and deletions). After this, the SyncML server sends the server modifications back to the SyncML client.

As described, for example, in “SyncML Sync Protocol, version 1.1.1” dated Oct. 2, 2002, (which is put forth by the Open Mobile Alliance (“OMA”) and provided at “http://www.openmobilealliance.org”, and for which the entire content is incorporated by reference herein), the SyncML synchronization protocol operates in both wireless and wired networks and supports several transfer protocols. The SyncML synchronization protocol can be implemented, for example, on top of HTTP protocol (Hyper Text Transfer Protocol), WSP protocol (Wireless Session Protocol) of the WAP (Wireless Application Protocol) standard, OBEX (Object EXchange Protocol) protocol used for cable links, such as the USB (Universal Serial Bus) or RS-232, or for short-range radio frequency (Bluetooth) links or infrared (IrDA) links, on top of a TCP/IP (Transport Control Protocol/Internet Protocol) stack, and also on top of an e-mail protocol (SMTP, Simple Mail Transfer Protocol).

### SUMMARY

According to one aspect of the present invention, a synchronization device (e.g., a synchronization server or gateway device) for synchronizing a client device with a remote database is provided. In one example, the synchronization device comprises logic operable to receive a client message and a sequence number associated therewith, compare the received sequence number with a stored sequence number, and cause a response based on the comparison of the received sequence number and the stored sequence number.

The comparison of the sequence numbers may indicate the previous response to the client device was successfully received or needs to be resent. Further, the comparison of the sequence numbers may indicate that the client device and/or the server has lost state (e.g., is out of sync with the database) and needs to refresh or perform a slow synchronization process with the database.

In one example, the sequence number is incremented by the client device for each message exchange. Accordingly, if the synchronization device receives a message and associated sequence number that has not been incremented (e.g., is equal to the last sequence number used or stored with the synchronization device), the previously sent response is sent to the client device. If the sequence number has been incremented appropriately, the synchronization device processes the received request and constructs a response. Further, if the sequence number varies by more than one, the synchronization device may issue a command to resynchronize.

In other examples, the synchronization device may increment the sequence number instead of or as well as the client device. Further, the sequence number may include any known pattern of indicia such as numbers, letters, or the like.

In another aspect of the present invention, a method for synchronizing a device with a remote database is provided. In one example, the method includes receiving a message and a sequence number associated therewith, comparing the received sequence number with a stored sequence number, and causing a response based on the comparing of the received sequence number and the stored sequence number.

In another aspect of the present invention, a computer program product for assisting data synchronization between a device and a remote database is provided. In one example, the computer program product comprises program code for receiving a message and a sequence number associated therewith, comparing the received sequence number with a stored sequence number, and causing a response based on the comparing of the received sequence number and the stored sequence number.

The present invention and its various aspects are better understood upon consideration of the detailed description below in conjunction with the accompanying drawings and claims.

### BRIEF DESCRIPTION OF THE DRAWINGS

FIG. 1 illustrates a prior art system and method for synchronizing a client device and a server device;

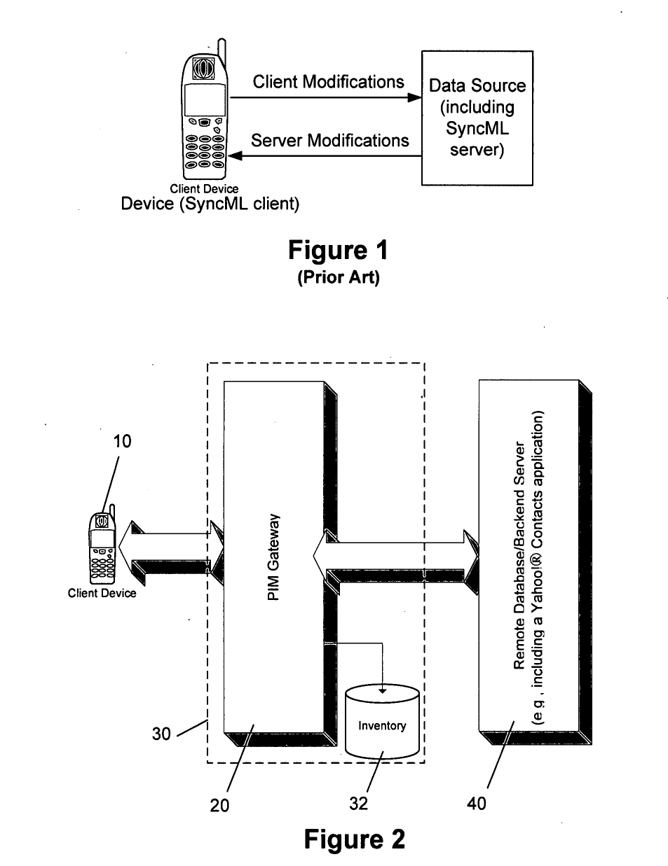

FIG. 2 illustrates a basic architecture in which various aspects described herein may operate;

FIGS. 3A and 3B illustrate exemplary process flows for handling messages including sequence numbers as described herein for a server device and client device respectively;

FIGS. 4A and 4B illustrate exemplary signaling diagrams of a slow synchronization (e.g., import) process and a fast synchronization process (e.g., normal synchronization), respectively, using sequence numbers; and

FIG. 5 illustrates an exemplary computing system that may be employed to implement processing functionality for various aspects of the invention.

### DETAILED DESCRIPTION

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

Broadly speaking, an exemplary synchronization system and method includes sending synchronization messages (e.g., responses, requests, etc.) using a sequence number that is incremented for different message exchanges. In one example, the protocol defines sequence numbers in the message exchanges to ensure that the synchronized databases on the device are current and that state has not been lost. For example, the sequence numbers allow for confirmation of a message and detection of an out of sync message from the client or server. Accordingly, a device, e.g., a synchronization server or gateway device, may receive messages from a client device having a sequence number associated therewith and respond to the message based on comparison of the received sequence number with a stored (locally or remotely) sequence number.

In one example, both client and server persist the request and response until confirmation is received. The confirmation will increment the sequence number by one; accordingly, the client and server are operable to send the same requests/response if the sequence number is repeated. A benefit of using sequence numbers in this fashion is that a database transaction is not needed (e.g., to determine if a response/request is a duplicate), resulting in the potential for a more efficient synchronization process than previous synchronization implementations.

In one example, sequence numbers are tracked for each application type separately (e.g., for each PIM application such as Contacts, Calendar, Tasks, and the like). Further, the sequence numbers may be used and tracked differently depending on the receiving device and type of message, e.g., including a server command or a device command. In one example, the sequence number is used by a client device to acknowledge commands initiated by the server (e.g., initiate an acknowledgement with the sequence number of the original message/command), but the device does not persist and check the server sequence number.

Additionally, in one example, the device initially sends a message to the server having an associated sequence number starting with 1 and increased by 1 (e.g., the first import command may have sequence id=1). The server thereafter tracks the sequence number and compares each received sequence number associated with received device messages with a stored sequence number. If the sequence numbers match, the server may resend the previous response (the match indicating that the previous response was not received because otherwise the sequence number would have been incremented for the new message exchange). If the received sequence number does not match or is not incremented correctly, indicating that the client device may have lost state and be out of sync with the server, the server may initiate a refresh command (or resynchronize) to the client device (e.g., “Init Refresh”) for causing a resynchronization process.

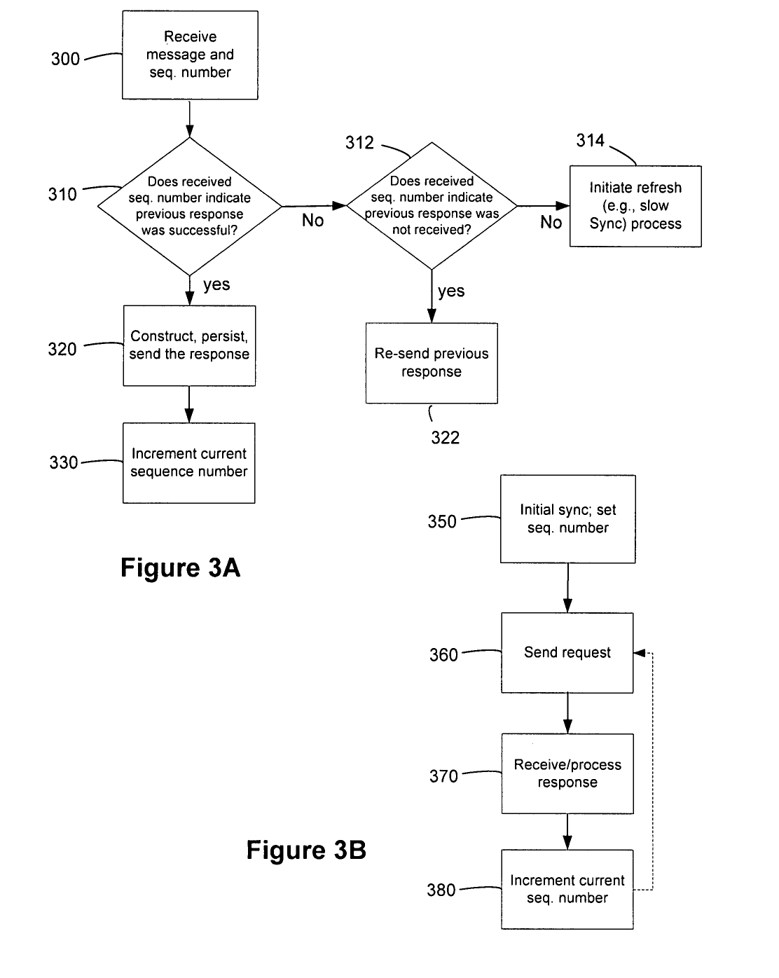

FIG. 2 illustrates an overview of an exemplary synchronization architecture in which some aspects of the present invention may be utilized. In one example, the architecture is based on an XML-schema; however, it will be recognized that aspects of the present invention may be used with various other synchronization protocols and architectures.

A client device 10 communicates with a Sync server 30, in this example, including a PIM gateway 20, a local database or inventory 32, all of which are operable to perform various synchronization processes. Various components of Sync server 30 may include servers, databases, and other well known components.

Client device 10 may communicate with Sync server 30 via a wireless network, such as a wireless gateway, e.g., a cellular, satellite, or other wireless network. Additionally, client device 10 may communicate via a non-wireless network such as a cable or fiber optic network, or a combination of wireless and non-wireless systems.

Client device 10 may include various devices including, for example, mobile devices such as a PDA, mobile telephone, smart phone, pager, walkie talkie, radio frequency (RF) device, infrared (IR) device, Wi-Fi device, pocket personal computer, tablet personal computer, laptop computer, and integrated devices combining one or more of the preceding devices, as well as a desktop computer, or the like. Client device 10 may include a processor connected to an input device such as a keyboard, a network interface, a memory, and a display. The memory may include logic (e.g., software, hardware, and/or firmware) operable with client device 10 to perform some of the functions described herein (e.g., using sequence numbers in message exchanges as described). Client device 10 may be operable to include a suitable interface for a messaging facility, such as an email inbox, instant messaging (IM), short messaging service (SMS), multimedia messaging service (MMS), and the like. Device 10 may further be operable to display a web browser for accessing the Internet, including webmail environments such as a Yahoo!® mail account or Hotmail® account, for example.

In one example, client device 10 communicates with Sync server 30 via Sync handler 20 such that client device 10 and Sync server 30 may exchange data (e.g., through a synchronization session to exchange client and/or server modifications to data). Through this communication, client device 10 is capable of synchronizing with synchronization data stored with Sync server 30. By way of example only, client device 10 and Sync server 30 may use the wireless application protocol (WAP) or other data communication protocol of client device 10 to communicate. One of ordinary skill in the art will recognize that the Wireless Application Protocol (WAP) is only one way in which a wireless device can access data on a network and that any such data transfer technology may be used to access and transfer electronic data. Further, the methods and systems described here are not limited to wireless communication methods and/or devices. For example, client device 10 may be wired directly to Sync server 30 (which may include a PC, for example).

In one example, Sync server 30 includes or accesses logic (e.g., software, hardware, and/or firmware) for comparing a sequence number associated a received client message to a stored sequence number (e.g., stored either locally with Sync server 30 or remotely with database 40), and causing a response to the client based on the received sequence number as described. The response may include the previously sent response, an acknowledgement, server items/information, a command to resynchronize, or the like. Further, Sync server 30 includes logic operable to increment or reset the stored sequence number as appropriate.

Sync server 30 further includes logic operable to communicate with at least one remote database or backend server 40. Remote database 40 includes, e.g., data associated with the local synchronization data on Sync server 30, data associated with client 10, and the like. In one example, the remote server 40 includes a user account such as a Yahoo!® user account, MSN® user account, or the like. Additionally, the remote server 40 may include one or more Personal Information Management (PIM) applications, such as Contacts, Calendar, or the like.

In one example, inventory 32 generally stores information such as CRCs, hash values, LUIDs, and the like for use when synchronizing client device 10 and may allow for the analysis of client modifications without accessing the remote database 40. In one example, Sync server 30 may initially respond to and synchronize client device 10 with data stored locally, e.g., with inventory 32. Further, data routed between client device 10 and remote database 40 may need to be modulated or transformed for use by client device 10. Accordingly, Sync server 30 may include or access a digest (not shown) to store data associated with such modifications of data to assist in preserving the integrity of data as it flows to and from client device 10.

It should be noted that although the exemplary methods and systems described herein describe use of separate servers and databases for performing the various functions, other embodiments could be implemented by storing the software or programming that operates some of the described functions on a single server or any combination of multiple servers as a matter of design choice so long as the functionality described herein is performed. Although not depicted in the figures, components, such as Sync server 30, generally include such art recognized components as are ordinarily found in server systems, including but not limited to processors, RAM, ROM, clocks, hardware drivers, associated storage, and the like.

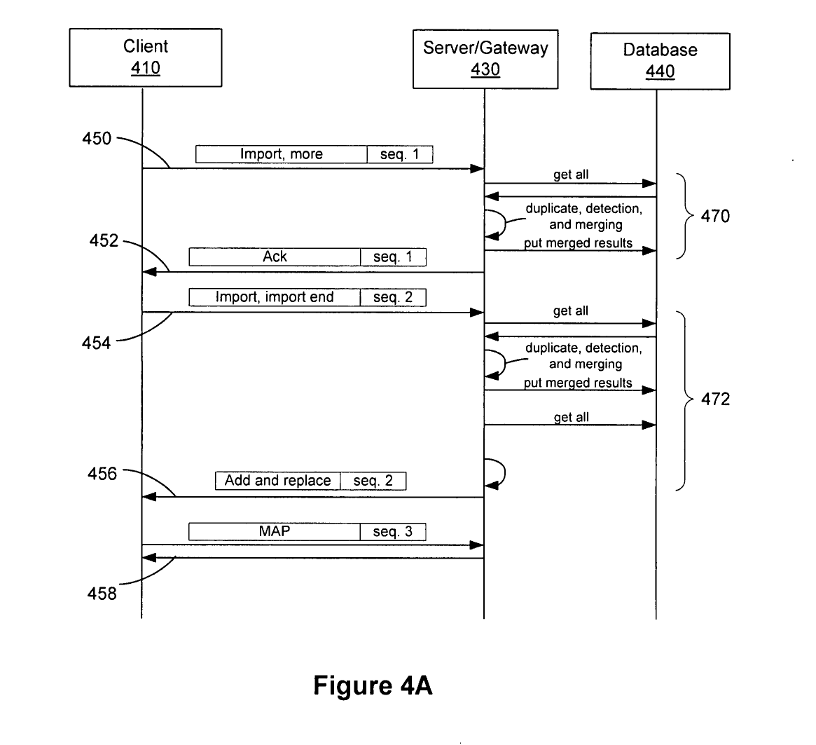

FIGS. 3A and 3B illustrate exemplary process flows for handling message exchanges having sequence numbers associated therewith for a server device and client device respectively. In particular, with reference first to FIG. 3A, a server device (e.g., a server or gateway device) receives a client request message and sequence number at 300. The client request may include an import command, add/update/delete entry, acknowledgement of a server command, and so on. As previously stated, the sequence number may include any indicia for tracking incremental messages as described.

The server device compares the received sequence number of the received message against a stored sequence number at 310 and 312. For example, the server device compares the numbers to determine if the received sequence number has been incremented to the next sequence number relative to the stored sequence number at 310, or if the received number equals the stored sequence number at 312. Determining if the sequence number has been incremented appropriately or is equal to the stored sequence number as indicated by 310 and 312 may be carried out by logic of the server in parallel or series (and in any order).

Additionally, if the sequence number is more than one sequence number greater than the current sequence number, the system determines that the server has lost state for the particular client device and may initiate a refresh process.

It is noted that in this example, the client device increments the number and responds, but does not persist and check the sequence number when receiving messages from the server device. In other examples, however, different schemes of using sequence numbers may be employed; for example, where only the server increments the sequence number, both the client and server increment the sequence number, and so on.

The stored sequence number may be stored remotely with the server device, e.g., in processing memory, or remotely, e.g., with a remote database. Additionally, the stored sequence number may be retrieved from a previous response or message exchange.

If the received sequence number associated with the received message indicates the previous response was received by the device (e.g., is incremented appropriately, e.g., one greater that the sequence number of the stored sequence number) the server device causes the construction of a response, persists the response, and sends the response as indicated in 320. The sent response, in this example, includes a sequence number equal to the received sequence number. Further, the server device increments the stored sequence number at 330, thereby matching the sequence number of the response sent.

If the sequence number associated with the message indicates the previous response was not received or processed appropriately (e.g., if the sequence number has not changed) the server re-sends the stored response as indicated at 322. For example, if the client received the previously sent response the sequence number should have been incremented by the client (the client-side process is described in greater detail with respect to FIG. 3B); accordingly, the previous response is resent if the sequence number indicates that the client may not have received the previous response.

Further, if the received sequence number is not incremented or does not match the stored sequence number, the server device may cause or initiate a refresh command to the client device at 314. In one example, the refresh process initiates a slow sync process, e.g., as described in U.S. patent application Ser. No. 11/273,891, filed Nov. 14, 2005, entitled DATA SYNCHRONIZATION AND DEVICE HANDLING, to L. Yang et al. Further, the sequence number for each application type may be reset after refreshing the client device.

The following illustrates an exemplary process flow for a synchronization device such as a server device or gateway device.

1. Receive client request

2. If (request seq=current/stored seq+1)

3. Construct the response

4. Persist the response

5. Send the response

6. Increment current seq

7. If (Request seq=current seq)

8. Re-send the stored response

9. If (Request seq is different from current or current+1)

10. Send back a response to initiate a slow sync

FIG. 3B illustrates an exemplary client process flow for handling message exchanges including sequence numbers. In an initial synchronization process, the client device may set the sequence number, e.g., to “1” at 350. The client device sends a message including a request at 360, the request including the sequence number.

A server device may process the request as described above with respect to FIG. 3A and cause an appropriate response. The response is received and processed by the client device at 370. For example, the process may include various commands such as add, replace, or delete records. The sequence number is then incremented at 380 for use with the next message (e.g., request) from the client to the server device.

An exemplary client process flow with sequence number is as follows:
1. If first time sync or slow sync flag is set, set sequence number (“seq”) to “1”
2. If there is a stored request message, re-send it. or construct a new request message
3. Persist the request message
4. Send request
5. Receive response
6. Set slow sync flag if the response requires this flag
7. Process response
8. Increment seq.
9. Remove stored request.
10. Remove slow sync flag.

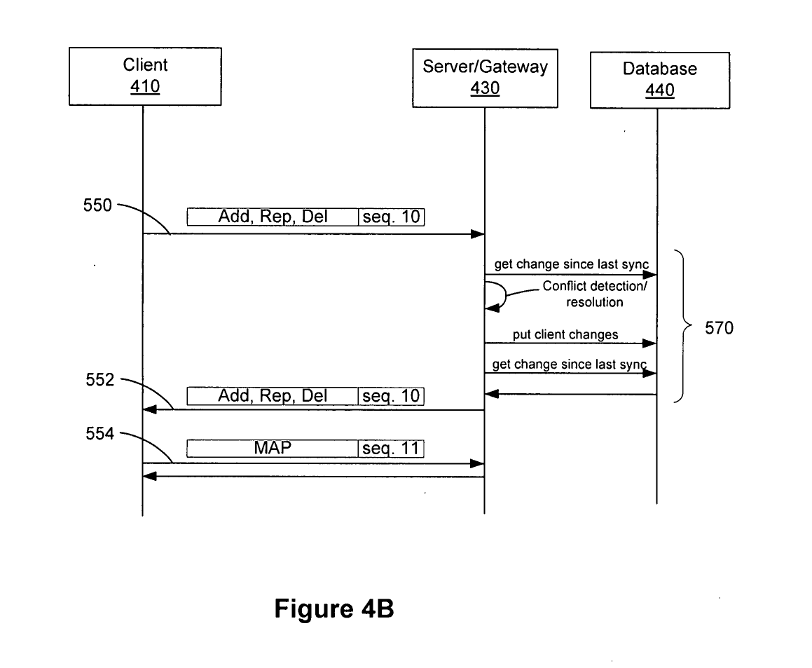

FIGS. 4A and 4B illustrate exemplary signaling diagrams of a slow synchronization (e.g., import) process and a fast synchronization process (e.g., normal synchronization), respectively, using sequence numbers. With reference initially to FIG. 4A, an initial import or slow synchronization process is illustrated for a client device 410 in communication with a server device 430 and database 440. Server device 430 may include a PIM gateway or other synchronization device included with sync server or the like.

In this example, after provisioning client device 410, client device 410 begins to send an import message/command at 450, where the first sequence number is set at “1” (or “0” or any other starting indicia). The import commands may be followed by an “import finished” command at 454, in this example associated with a sequence number 2 (of course, the sequence number may be incremented for each successive import message exchange during the slow synchronization process).

As data is imported to server device 430, server device 430 engages database 440 to perform various well known actions such duplicate and merging processing to synchronize the incoming data with database 440 as indicated at 470 (and similarly 472).

After duplicate and merging processing, server device 430 returns updates to client device 410 with items at 456. In one example, the server items are associated with a sequence number. In this example, the sequence numbers are incremented by the client device 410 for successive message exchanges. Thus, the sequence number is “1” with the ack at 452 and incremented to “2” for server items at 456. In other examples, in addition to or instead of client device 410 incrementing the sequence number, server device 430 may increment the sequence number, e.g., to “3” for the response to an imported server item associated with sequence number “2.”

In this particular example, if the sequence number at 454 is not incremented appropriately, e.g., includes the sequence number associated with the last import (e.g., sequence number “1”), server device 430 may resend the previous response. Further, if the previous response at 456 is stored locally with server device 430, the exchange with database 440 at 470 will not be necessary. Accordingly, correcting the out of sync situation may be performed relatively fast as a database transaction may be avoided.

Additionally, ID mapping may be performed through a message exchange 458 associated with sequence number “3.” In one example, ID mapping data is stored only with the server device 430. Commands coming from client device 410 use LUIDs, where the server device keeps the mapping to identify the commands, and the “ADD” commands coming from server use GUIDs. After the client device 410 creates items in its local database a map command may inform the server about the new LUIDs. For all subsequent commands for these items (e.g., UPDATE, DELETE) the server uses the LUIDs. Of course other ID mapping implementations are possible and contemplated.

It should also be noted that exchanges between server device 430 and database 440 may similarly include and use sequence numbers in a similar or identical fashion as described with respect to client device 410 and server device 430. In other examples, conventional data integrity methods may be employed without the use of sequence numbers.

With reference now to FIG. 4B, a regular or fast synchronization process is illustrated. An exemplary synchronization session generally begins with client device 410 sending local changes at 550 to server device 430 since the last synchronization session (if there are no changes client devices 410 may send an empty request, thereby prompting server device 430 to respond with any database 440 changes).

Server device 430 engages database 440 to perform various well known actions such as conflict detection and resolution processes to synchronize the incoming changes, if any, with database 440 as indicated at 570. Server device 430 responds with changes, if any, since the last synchronization at 552. In one example, the response includes the sequence number of the initial message with client changes (e.g., sequence number 10). In other examples (not shown), the response could include an incremented sequence number (e.g., sequence number 11).

Client device 410 sends acks for all commands and Maps for the ADD commands at 554. The client device 410 further increments the sequence number (e.g., to sequence number 11) for these messages. Accordingly, and as previously described, if server device 430 receives sequence number 10, the previously sent response at 552 may be resent if still in local memory of server device 430, and without the database exchange at 570. Further, if the number is neither 10 nor 11, server device 430 may initiate a message to cause the client device 410 to refresh or perform a slow synchronization process.

The following illustrates exemplary sync protocol specifications for use with PIM based applications. In this example, the PIM sync protocol is HTTP based, e.g., the requests are sent as POST HTTP requests. The requests and responses contain WBXML payload in an HTTP body.

The following includes exemplary protocol status codes to aid in the following description. The protocol status codes are contained in the “status” field of the WBXML response.
200—OK Command processing was successful
201—OK More Data Request processing was successful, device must repeat the poll.
400—Invalid request, missing parameter, etc. (requires bug fix on device). The info field should contain textual information what a wrong in the request.
401—Unknown IMEI—the device is not provisioned; device must provision and retry the request.
403—Authorization failed—the device must get new cookies and retry the request.
404—Application type not supported. The device should stop polling and change propagation for the application type. The info contains the application types (one character per application type i.e. “34”=addr+cal)
417—Refresh Required—The info contains the application types (one character per application type i.e. “34”=addr+cal)
301—Moved permanently. Device moved to another blade, datacenter. The info contains the new URL of the server. For all subsequent requests the device must use the new URL.

Further, exemplary acks status codes are as follows, where each ack command has a separate status code. This field describes the status of the single command operation.
200—OK
411—Device full there is not more space left on the device.
500—Unknown error
502—Parse error. Device was not able to parse the command for unknown reason. The server may try to send a “simplified” version of the item containing only the basic fields.

The API supports various PIM application types such as Contacts, Calendar, Tasks, and the like. Depending on the place (URL, binary command) they may be represented as one character string or one byte number. The codes of the application types may be equal to those of server device or database, for example:

2—Tasks

3—Contacts

4—Calendar

The following commands may be supported in the exemplary protocol:

Device ← → Server
Add—add new PIM Entry
Update—update the PIM Entry
Remove—remove the PIM Entry

Device—Server
Ack—ack a server command (contains the sequence number of the original command)
AckAll—ack all commands till sequence number.
Map—maps the guids to luids
Import—import the PIM items from device.
ImportEnd—indicates that import is finished.

Exemplary requests and responses are illustrated below to aid in the understanding of various aspects related to the use of sequence numbers. In particular, exemplary requests and responses are illustrated for initial synchronization processes and a common synchronization session for the above described exemplary PIM Sync protocol.

Initial Sync/Device import:

```
<?xml version=“1.0” encoding=“UTF-8”?>
<request>
    <app>3</app>
    <seq>1</seq>
    <cmd>
        <type>10</type>
        <id>1</id>
        <body>
BEGIN:VCARD
VERSION:2.1
N;CHARSET=UTF-8:ADAC Pannenhilfe
TEL;PREF;CELL;VOICE:+49172222222
TEL;FAX:+49172222222
END:VCARD
        </body>
    </cmd>
    <!- here comes more import commands -->
</request>
```

Server accepts with 200:

```
<?xml version=“1.0” encoding=“UTF-8”?>
<response>
    <app>3</app>
    <info>OK</info>
    <status>200</status>
</response>
```

Device sends the last import commands followed by import finished:

```
<?xml version=“1.0” encoding=“UTF-8”?>
<request>
    <app>3′</app>
    <seq>2</seq>
    <cmd>
        <type>10</type>
        <id>101</id>
        <body>
BEGIN:VCARD
VERSION:2.1
N;CHARSET=UTF-8:Uniejow
TEL;PREF;WORK;VOICE:0048603391076
TEL;VOICE:0048603391076
END:VCARD
        </body>
    </cmd>
    <cmd>
        <type>11</type>
    </cmd>
</request>
```

Server sends commands, and responses with 201 to determine that there are no changes:

```
<?xml version=“1.0” encoding=“UTF-8”?>
<response>
    <app>3</app>
    <info>OK</info>
    <status>201</status>
    <cmd>
        <type>1</type>
        <cmdid>0</cmdid>
        <id>Y8360</id>
        <body>
BEGIN:VCARD
VERSION:2.1
N:ADAC Pannenhilfe
TEL;HOME;VOICE:+49172222222
TEL;PREF;CELL;VOICE:+49172222222
TEL;VOICE:+49172222222
END:VCARD
        </body>
    </cmd>
</response>
```

Server sends ack and map command:

```
<?xml version=“1.0” encoding=“UTF-8”?>
<request>
    <app>3</app>
    <seq>3</seq>
    <cmd>
        <type>5</type>
        <id>Y8360</id>
        <luid>1.vcf</luid>
    </cmd>
    <cmd>
        <type>7</type>
        <status>200</status>
        <cmdid>0</cmdid>
        <id>Y8360</id>
    </cmd>
</request>
```

Common synchronization sessions are also illustrated as follows below beginning with a device sending changes (e.g., 1 add command):

```
<?xml version=“1.0” encoding=“UTF-8”?>
<request>
    <app>3</app>
    <seq>5</seq>
    <cmd>
        <type>1</type>
        <id>18.vcf</id>
        <body>BEGIN:VCARD
VERSION:3.0
FN:Szumilas , Agnieszka
N:Szumilas;Agnieszka;;;
REV:2005-12-09
TEL;TYPE=WORK:0048745555555
UID:18.vcf
END:VCARD
    </body>
    </cmd>
</request>
```

Server responds with its changes (e.g., 1 add, 1 update)

```
<?xml version=“1.0” encoding=“UTF-8”?>
<response>
    <app>0</app>
    <info>OK</info>
    <status>200</status>
    <cmd>
        <type>1</type>
        <cmdid>0</cmdid>
        <id> Y8361</id>
        <body>BEGIN:VCARD
VERSION:3.0
EMAIL;TYPE=HOME:dsmyka&#64;box43.pl
FN:Smyka , Damian
N:Smyka;Damian;;;
REV:2005-12-09
TEL;TYPE=HOME:075555555
UID:71.vcf
END:VCARD
</body>
    </cmd>
</response>
```

Device sends acks and map:

```
<?xml version=“1.0” encoding=“UTF-8”?>
<request>
    <app>3</app>
    <seq>6</seq>
    <request>
    <cmd>
        <type>5</type>
        <id>Y8361</id>
        <luid>1.vcf</luid>
    </cmd>
    <cmd>
        <type>7</type>
        <status>200</status>
        <cmdid>0</cmdid>
        <id>Y8360</id>
    </cmd>
</request>
```

OK:

```
<?xml version=“1.0” encoding=“UTF-8”?>
<response>
    <app>3</app>
    <info>OK</info>
    <status>200</status>
</response>
```

While aspects of the invention, including the above described systems and methods, are described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic, and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

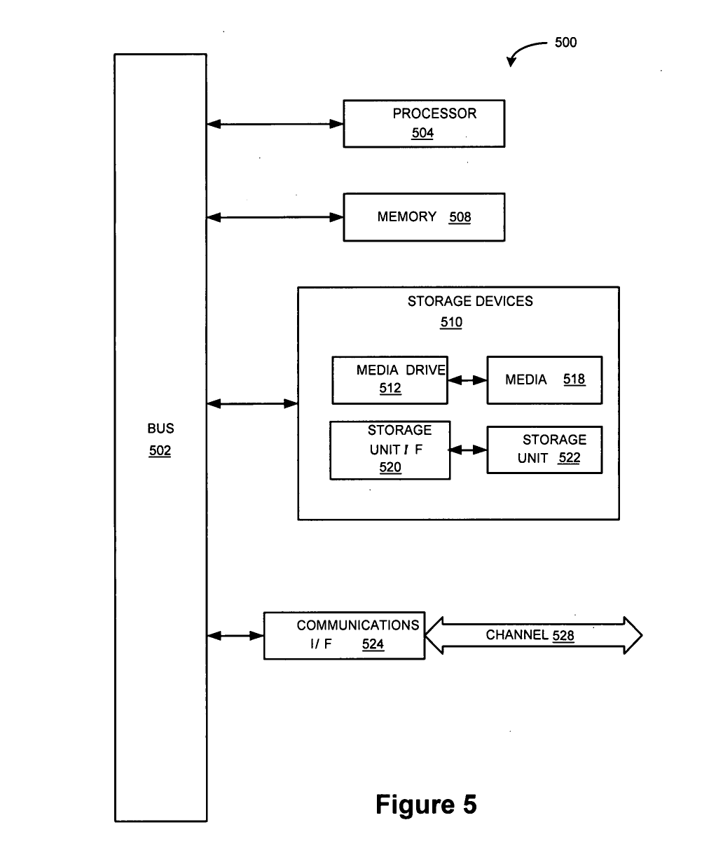

FIG. 5 illustrates an exemplary computing system 500 that may be employed to implement processing functionality for various aspects of the invention (e.g., as a synchronization server, gateway device (e.g., a PIM gateway device), client device, database, combinations thereof, and so on). Those skilled in the relevant art will also recognize how to implement the invention using other computer systems or architectures. Computing system 500 may represent, for example, a desktop, mainframe, server, client, or any other type of special or general purpose computing device as may be desirable or appropriate for a given application or environment. Computing system 500 can include one or more processors, such as a processor 504. Processor 504 can be implemented using a general or special purpose processing engine such as, for example, a microprocessor, microcontroller or other control logic. In this example, processor 504 is connected to a bus 502 or other communication medium.

Computing system 500 can also include a main memory 508, for example random access memory (RAM) or other dynamic memory, for storing information and instructions to be executed by processor 504. Main memory 508 also may be used for storing temporary variables or other intermediate information during execution of instructions to be executed by processor 504. Computing system 500 may likewise include a read only memory (“ROM”) or other static storage device coupled to bus 502 for storing static information and instructions for processor 504.

The computing system 500 may also include information storage mechanism 510, which may include, for example, a media drive 512 and a removable storage interface 520. The media drive 512 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 518 may include, for example, a hard disk, floppy disk, magnetic tape, optical disk, CD or DVD, or other fixed or removable medium that is read by and written to by media drive 514. As these examples illustrate, the storage media 518 may include a computer-readable storage medium having stored therein particular computer software or data.

In alternative embodiments, information storage mechanism 510 may include other similar instrumentalities for allowing computer programs or other instructions or data to be loaded into computing system 500. Such instrumentalities may include, for example, a removable storage unit 522 and an interface 520, such as a program cartridge and cartridge interface, a removable memory (for example, a flash memory or other removable memory module) and memory slot, and other removable storage units 522 and interfaces 520 that allow software and data to be transferred from the removable storage unit 518 to computing system 500.

Computing system 500 can also include a communications interface 524. Communications interface 524 can be used to allow software and data to be transferred between computing system 500 and external devices. Examples of communications interface 524 can include a modem, a network interface (such as an Ethernet or other NIC card), a communications port (such as for example, a USB port), a PCMCIA slot and card, etc. Software and data transferred via communications interface 524 are in the form of signals which can be electronic, electromagnetic, optical, or other signals capable of being received by communications interface 524. These signals are provided to communications interface 524 via a channel 528. This channel 528 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 508, storage device 518, storage unit 522, or signal(s) on channel 528. These and other forms of computer-readable media may be involved in providing one or more sequences of one or more instructions to processor 504 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into computing system 500 using, for example, removable storage drive 514, drive 512 or communications interface 524. The control logic (in this example, software instructions or computer program code), when executed by the processor 504, causes the processor 504 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention. Moreover, aspects of the invention describe in connection with an embodiment may stand alone as an invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. A device for engaging in synchronization sessions with a client device, the device comprising logic operable to:
receive a client message and a sequence number associated therewith;
compare the received sequence number with a stored sequence number; and
cause a response based on the comparison of the received sequence number and the stored sequence number.

2. The device of claim 1, wherein the response comprises a previously sent response if the comparison indicates the previous response was not received.

3. The device of claim 1, wherein the response comprises a previously sent response if the received sequence number and the stored sequence number are equal.

4. The device of claim 1, wherein the response comprises a command to resynchronize if the comparison indicates lost state with the client.

5. The device of claim 1, wherein the response comprises a command to resynchronize if the comparison indicates the received sequence number and the stored sequence number differ by more than one.

6. The device of claim 1, further comprising logic operable to cause the construction of a response to the client message and associating the received sequence number therewith.

7. The device of claim 1, further comprising logic operable to cause the construction of a response to the client message and associating a sequence number incremented relative to the received sequence number therewith.

8. A device for engaging in synchronization sessions with a remote device, the device comprising logic operable to:
receive a message and a sequence number associated therewith;
compare the received sequence number with a stored sequence number; and
process the message based on the comparison of the received sequence number and the stored sequence number.

9. The device of claim 8, comprising logic operable to increment the sequence number for use with a subsequent message.

10. The device of claim 8, wherein the stored sequence number is associated with a previously sent request and the received message comprises a response to the previously sent request.

11. The device of claim 8, wherein if the comparison indicates the response is to the previously sent request processing the response.

12. The device of claim 8, wherein if the comparison indicates the response is not to the previously sent request resending the previously sent request.

13. A method for synchronizing a device with a remote database, the method comprising:
receiving a message and a sequence number associated therewith;
comparing the received sequence number with a stored sequence number; and
causing a response based on the comparing of the received sequence number and the stored sequence number.

14. The method of claim 13, wherein the response comprises a previously sent response if the comparison indicates the previous response was not received.

15. The method of claim 13, wherein the response comprises a previously sent response if the received sequence number and the stored sequence number are equal.

16. The method of claim 13, wherein the response comprises a command to resynchronize if the comparison indicates lost state with the client.

17. The method of claim 13, wherein the response comprises a command to resynchronize if the comparison indicates the received sequence number and the stored sequence number differ by more than one.

18. The method of claim 13, further causing the construction of a response to the client message and associating the received sequence number therewith.

19. The method of claim 13, further causing the construction of a response to the client message and associating a sequence number incremented relative to the received sequence number therewith.

20. A computer program product comprising program code for assisting data synchronization between a device and a remote database, the computer program instructions comprising program code for:
receiving a message and a sequence number associated therewith;
comparing the received sequence number with a stored sequence number; and
causing a response based on the comparing of the received sequence number and the stored sequence number.

21. The computer program product code of claim 20, wherein the response comprises a previously sent response if the comparison indicates the previous response was not received.

22. The computer program product code of claim 20, wherein the response comprises a previously sent response if the received sequence number and the stored sequence number are equal.

23. The computer program product code of claim 20, wherein the response comprises a command to resynchronize if the comparison indicates lost state with the client.

24. The computer program product code of claim 20, wherein the response comprises a command to resynchronize if the comparison indicates the received sequence number and the stored sequence number differ by more than one.

25. The computer program product code of claim 20, further comprising program code for causing the construction of a response to the client message and associating the received sequence number therewith.

26. The computer program product code of claim 20, further comprising program code for causing the construction of a response to the client message and associating a sequence number incremented relative to the received sequence number therewith.
